(19) United States
(12) Patent Application Publication
(10) Pub. No.: US 2025/0222509 A1
(43) Pub. Date: Jul. 10, 2025

(54) ISOSTATIC INTERFERENCE-FIT JOINT

(71) Applicant: Luis Osvaldo CASTRO ARRIAGADA, Copiapó (CL)

(72) Inventor: Mauricio MULET MARTÍNEZ, Vallenar (CL)

(21) Appl. No.: 19/091,685

(22) Filed: Mar. 26, 2025

Related U.S. Application Data
(63) Continuation-in-part of application No. PCT/IB2023/059527, filed on Sep. 26, 2023.

(30) Foreign Application Priority Data
Sep. 26, 2022 (CL) 202202608

(51) Int. Cl. B21D 26/047

(52) U.S. Cl. CPC B21D 26/047

(57) ABSTRACT

A two-section assembly chamber includes a section S1 (11) and a section S2 (12), whose shapes are selected between cylindrical, where section S1 (11) has a diameter larger than the section S2 (12), and in the shape of a conical frustum, where sections S1 (11) and S2 (12) form a conical frustum, where the conical frustum begins at S1 (11) with the wider part and ends at S2 (12) with the narrower part, both sections S1 (11) and S2 (12) are joined or welded together, and are removable, each having respective caps (21, 22), wherein the assembly chamber has at least one perforation for introducing a pressurized fluid. The assembly chamber is configured so that a tube (30) or a second chamber, which has a larger diameter than the section S2 (12), is assembled within the inner diameter of the section S2 (12).

It has been known for a long time that the internal pressure exerted by a fluid in a thick-walled cylindrical chamber causes greater tangential stress on the wall in the area closest to the center and less towards the periphery, which limits the pressure that a chamber can contain. It has long been sought some method of construction of thick-walled cylindrical chambers which allows a more uniform tangential stress in the wall product of the internal pressure, regardless of whether it is at a point closer to the central axis or at the periphery.

If there is a way in which the pressure inside a cylindrical chamber produces a uniform tangential stress across the width of the cylinder wall, it could receive much greater pressure than a simple thick-walled chamber. That is why it is sought an economical way that allows higher pressure when making artillery guns, pasteurizing food by pressure, high-pressure metallurgy, compressing hydrogen, etc.

A method of coiled cylinder has been found, which consists of winding several kilometers of a rectangular wire, with calculated pressure, producing a thick cylinder that resists as much pressure as if it were uniform on the wall, when it is under pressure. This is the coiled chamber used by companies to prepare food by the HPP system; or in metallurgy at high pressure by the HIP system.

The coiled chamber has the serious disadvantage that it does not support the pressure in axial direction, so it is necessary to put external yokes and special covers in axial direction, which cannot rest on the cylindrical wall but on an external structure. It is a system that has several hydraulic cylinders to move the chamber and the covers and it is expensive to build, because it is essential to have a device that rolls the plate in the cylinder with calculated tension.

### CYLINDRICAL TUBES OR CHAMBERS WITH INTERFERENCE

This is the invention filed with INAPI, CL 202101788, “Tube or chamber interference-joined by of isostatic pressure”, which is a process by which tubes are assembled with interference, for which it was necessary to build special mechanism that has “tubular chambers” and describe how to assemble them at high isostatic pressure inside an “assembly chamber”, whose only particularity that is it is a larger cylinder of high pressure. As many cylinders as desired are assembled, which have high interference at atmospheric pressure, when they are not assembled.

The interference in a tube made of two or several thin concentric cylinders causes the thick-walled tube that is being made, when subjected to internal pressure, to produce a more uniform tangential stress and support without inconvenience higher pressure than a simple thick-walled cylindrical chamber. When it does not have internal pressure, the internal tangential stress in the wall is pre-compressed towards the inner side and somewhat pre-stressed towards the outer side.

Another way to assemble cylinders with interference, which can be eliminated by temperature difference, when one cylinder can be mounted on another, it has the difficulties of heat transfer between the hot cylinder and the cold cylinder, and the interference achieved is low. In this way it is used to assemble parts by mechanical means by applying blows, such as a railroad wheel or a gear to its axle, etc.

Another way of joining cylinders by interference, by a slight interference, is the patent of the SPANISH OFFICE OF PATENTS AND TRADEMARKS, Publication Number 2 635 277; “PROCEDURE FOR THE MANUFACTURE OF CONTAINERS FOR THE TREATMENT OF HIGH-PRESSURE FOOD”, but it does not seek to generate pressure, but as a method of “autofrettage” of two cylinders of different material, which are put with slight interference. It is used as a way of constructing the stainless-steel cylinder with a high strength steel cylinder, which does not come in contact with the food.

### NEW INVENTION

It is a new assembly chamber, which has special characteristics in its shape, to assemble tubes that allow high pressure. It is a new chamber that is patented, plus a new process that allows to assemble tubes in a different way to the existing chambers.

The new assembly chamber has special characteristics in its shape; it is a chamber that has at least two well defined straight or cylindrical sections, one S1 (11) is larger than the other S2 (12), which can be joined with a short conical frustum piece; or it is somewhat a cone frustum, with a section S1 at the beginning of the wide part and ends with a section S2 in the narrowest part; with two caps (21, 22).

This new assembly chamber is also to produce a new interference-joined tube or cylinder, which is eliminated by isostatic pressure.

Being the assembly chamber without pressure, it is loaded with a new tube or chamber (30), on the wide side of the assembly chamber S1, which can enter on the wide side without pressure and cannot enter on the narrow side, because it makes interference while unpressured.

The assembly chamber is closed and placed in vertical position, with the wide section upwards and begins to expand with a fluid that is poured into it, through any perforation where a valve is placed. The assembly chamber begins to expand in all its length, enough for the tube (30) to descend or fall; which does not expand when the internal pressure rises, which rises on both sides of the tube; from section S1 to section S2 now expanded.

Then the fluid is removed, the pressure drops and the S2 section is assembled to the tube (30). The assembly chamber is disassembled to leave section S2 incorporated externally to the tube, joined by interference. New sections can be incorporated into the tube, repeating the experience to obtain a tube much stronger than a normal one of the same thickness.

It is possible to glue the entire surface of the tube before loading the assembly chamber, or after disassembly to spot weld, to ensure that they do not slide over each other already assembled.

### DESCRIPTION OF FIGURES

FIG. 1: Description of the new assembly chamber with two straight and cylindrical sections, section S1 being larger and section S2 being smaller. Parts (11 and 12) are cylindrical.

FIG. 2: Description of a new slightly conical frustum-shaped assembly chamber, with the section starting to narrow from S1 to end with another section S2; it is just a conical frustum-shaped cylinder.

FIG. 3: Shows a tube (30) that fits into section S1 and does not fit into section S2 without pressure.

FIG. 4: Shows the unpressurized loaded chamber, where the inner tube (30) fits only in section S1 and does not enter section S2.

FIG. 5: Shows the pressurized loaded chamber, it has slightly increased its diameter and the inner tube (30) now fits inside section S2.

FIG. 6: The interference-joined assembled cylinder (30) is pulled out, and section S2 (12) now forms part of the assembled cylinder.

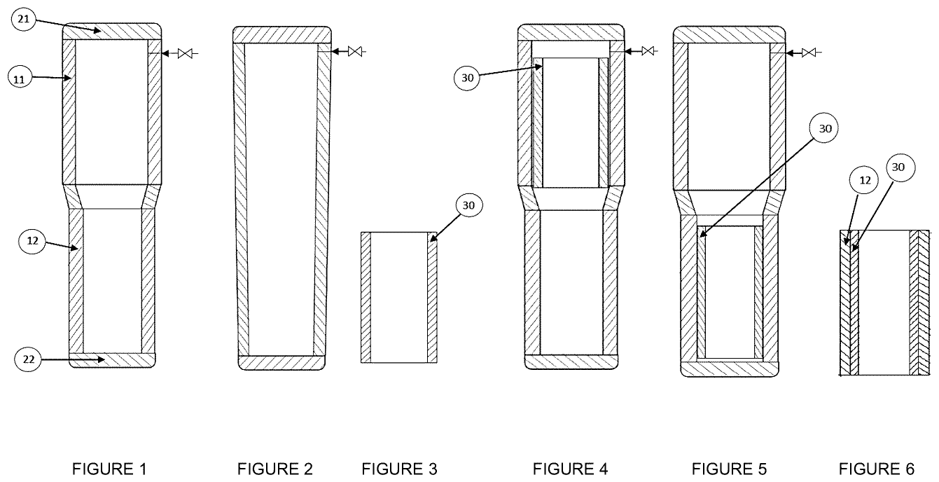

1. A two-section assembly chamber, CHARACTERIZED in that it comprises:
a section S1 (11) and a section S2 (12), whose shapes are selected between cylindrical, where section S1 (11) has a diameter larger than the section S2 (12), and in the shape of a conical frustum, where sections S1 (11) and S2 (12) form a conical frustum, where the conical frustum begins at S1 (11) with the wider part and ends at S2 (12) with the narrower part;
both sections S1 (11) and S2 (12) are joined or welded together, and are removable, each having respective caps (21, 22), wherein the assembly chamber has at least one perforation for introducing a pressurized fluid, and
wherein the assembly chamber is configured so that a tube (30) or a second chamber, which has a larger diameter than the section S2 (12), is assembled within the inner diameter of the section S2 (12) by expanding the inner diameter of the section S2 (12) as a result of introducing the pressurized fluid through the at least one perforation, wherein the inner diameter of S1 (11) is larger than the outer diameter of the tube (30) or the second chamber, thereby allowing the section S1 (11) to be separated from the section S2 (12).

2. A method for assembling a tube in an assembly chamber and obtaining a tube made of two or more concentric cylinders, CHARACTERIZED in that it comprises the steps of:
a) providing an assembly chamber as the one described in claim 1;
b) loading the assembly chamber with a tube (30) or a second chamber, wherein the tube (30) or the second chamber fits into the first section S1 (11) of the assembly chamber and does not fit into the section S2 (12);
c) closing the assembly chamber with the caps (21, 22) and arranging the assembly chamber in a vertical position, wherein the section S1 (11) faces upwards;
d) introducing into the assembly chamber a pressurized fluid through the at least one perforation of the assembly chamber until the internal diameter of the sections S1 (11) and S2 (12) of the chamber expands, until the tube (30) or the second chamber descends by gravity into the section S2 (12);
e) extracting the fluid from the assembly chamber, leaving the tube (30) or the second chamber assembled inside the section S2 (12) of the assembly chamber; and
f) separating the section S1 (11) from the section S2 (12) of the assembly chamber, wherein the section S2 (12) is assembled with the tube (30) or with the second chamber, thus obtaining a tube made of two or several concentric cylinders.
